(19) United States
(12) Patent Application Publication
(10) Pub. No.: US 2006/0210352 A1
(43) Pub. Date: Sep. 21, 2006

(54) Electric toothpaste dispensing toothbrush mechanism

(76) Inventor: Lonnie A. Clark, Arlington, WA (US)

Correspondence Address: LONNIE A. CLARK, 510 N HIGH ST., ARLINGTON, WA, 98223, US

(21) Appl. No.: 11/083,274

(22) Filed: Mar. 17, 2005

(51) Int. Cl. B43K 5/06; A46B 11/04

(52) U.S. Cl. 401/277; 401/270

(57) ABSTRACT

An Electric Toothpaste Dispensing Toothbrush Mechanism is an integration between toothbrushes and toothpaste. It is the first integration to be completely automatic and works with electric toothbrushes at the touch of a button. It uses a gear reduction system to use the same motor to turn both the plunger shaft and the shaft meant to vibrate the bristles of the toothbrush head. This rotation causes the plunger inside the cartridge of toothpaste to rise and push toothpaste out of the toothbrush head for the user. The toothpaste reservoir contains enough product for preferably a month so that the user might also change bristle heads on a regular basis as well. As such, the toothpaste cartridge and brush head along with the upper half parts are totally interchangeable. Thus introducing a new breed of oral care convenience.

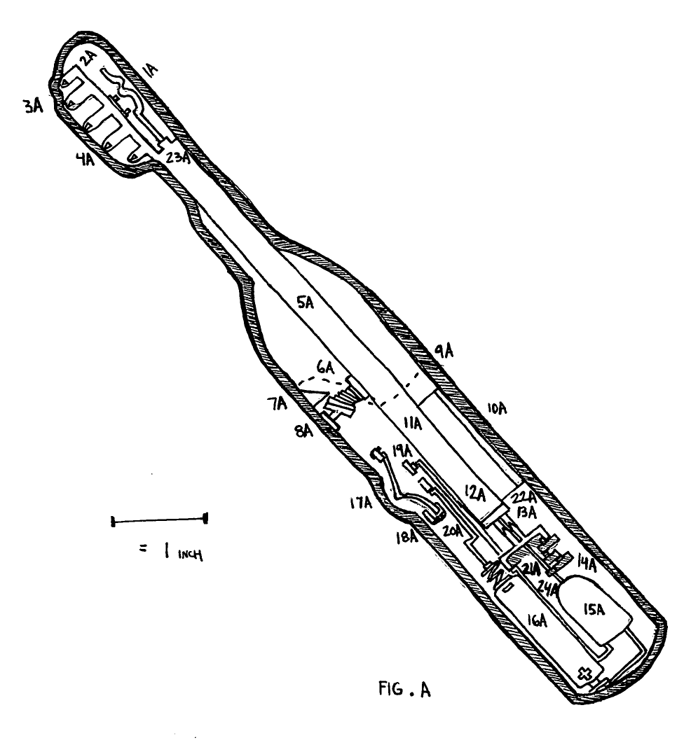

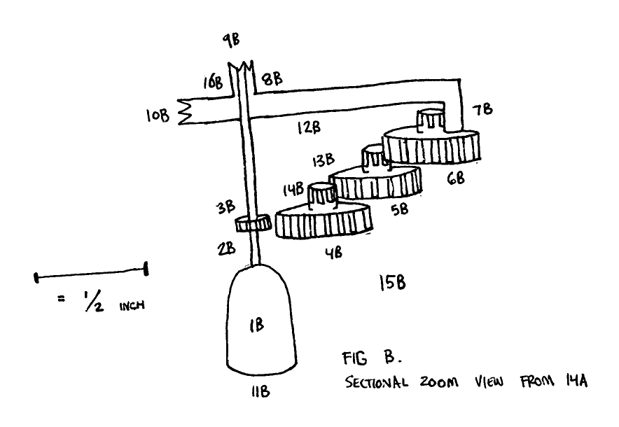

The title of the invention in question is the “Electric Toothpaste Dispensing Toothbrush Mechanism,” and describes the primary function processes of my invention in a very forthright manner.

### CROSS REFERENCE TO RELATED APPLICATIONS

### STATEMENT REGARDING FEDERALLY SPONSORED RESEARCH OR DEVELOPMENT

Not Applicable.

### REFERENCE TO SEQUENCE LISTING, A TABLE, OR COMPUTER PROGRAM LISTING COMPACT DISC APPENDIX

Not Applicable

### BACKGROUND OF THE INVENTION

The field of the invention is to provide further convenience for travel and functionality with toothbrushes by eliminating the need for toothpaste by intergrading a toothpaste cavity that automatically dispenses in sync with automatic toothbrushes bristle vibrations.

The electric toothbrush has offered much convenience for oral hygiene in the past thanks to great inventors such as J. Gold and the Motor Driven Toothbrush in U.S. No. Pat. 2,310,626. As of late however, many innovational attempts are being made at full integration between a toothbrush apparatus and toothpaste (dentifrice); thus providing two oral hygiene product in the form of one; thereby providing increased convenience for travel, etc. and functionality. However, recent attempts at this endeavor all end up in some sort of manual power rather than an automatic distribution. This in turn only provides the benefit of not having to carry toothpaste but then still requires the equivalent or greater exertion of manual power for the turning of gears or pistons, etc. At the same time, additional dilemmas exist such as overuse of toothpaste (dentifrice) possibly causing harm to the teeth due to overexposure of Fluoride found in toothpaste that in large amounts can destroy teeth enamel. This can present the opportunity for large amounts of wasted oral care product or harmful exposure to teeth due to possible manual applications of toothpaste; especially prominent in unfamiliar devices that present some stimulation. These examples can be seen in modern day toothpaste dispensing toothbrushes.

### BRIEF SUMMARY OF INVENTION

My invention relies on planetary or similar gear systems to increase gear ratios to greatly differentiate the amount of RPM from the drive shaft driving the rocker arm, (as is common in most automatic toothbrushes) or the likened method for obtaining automated mobility; for automated bristle movement between the distribution of toothpaste provided from a piston that rotates up a groove track inside a cavity filled with dentifrice. This can provide automatic toothpaste distribution while the user is brushing their teeth with the said equipped toothbrush. This eliminates the limited functionality of previous toothpaste dispensing toothbrushes. Due to a regulated RPM that remains constant throughout brushing; dentifrice is distributed smooth and evenly throughout the course of brushing. This eliminates wasteful usage of toothpaste due to error on behalf of the user due to overexertion of manual force or no know-how of proper amount to be used. Without wasteful or excessive usage of oral care products teeth enamel damage no longer becomes a pertinent issue and consumers have wasted less product; thus are prone to the belief that the product actually contains more; or they are getting “more for their money.” I aim to have this invention fix the gap between the merging of toothbrush and proving toothpaste from the same device; so as, it may provide a higher level of oral care convenience and functionality.

### BRIEF DESCRIPTION OF THE SEVERAL VIEWS OF THE DRAWING

The concept of the invention will be better understood when consideration is given to following referential drawings wherein:

FIG A. is a top view of the preferred embodiment of the intergraded invention mechanism into a practical electric toothbrush; the concept of the invention.

FIG B. is the sectional zoom view of the working planetary gear train, the preferred embodiment of such; which may also present itself in different configurations of the same functionality and method.

The same references here made are made to the disclosed drawing within.

### DETAILED DESCRIPTION OF THE INVENTION

Referring directly to the drawings for assisted description of the inter-workings of my invention will noted by a quick reference to the description number; noted on the actual drawing page with a close proximity to the reference therein.

Figure A. a top viewing of the actual drawing can be used to show the complete process of the invention. At the top head of the toothbrush we see a standard practical inexpensive drive shaft assembly for toothbrush bristle rotation (1A-2A). At descriptor 1A we see the drive shaft with crook head assembly so when in rotation they alternately strike the circular motion disc 2A that has panels affixed at 2 and 8 o'clock when in a neutral position so they can initiate alternate rotation of the disc approx. 24.5 degrees to promote a vibrate motion for brushing; this is merely an example of the possible candidate for my invention: the integration between any electric toothbrush and an automatic toothpaste distribution system, which, include the rubber bristles 3A that may be used in such an operation. Although these rubber bristles are not mandatory they are preferred but may be left out altogether for a suitable replacement method such as holes in head area where bristles exit for escape of the toothpaste. The rubber bristles preferably contain a sort of aero spike of rubber 4A; an inverted opening that tapers down the escape of materials, this is to allow the toothpaste to travel at a steady rate with little mess and allow enough pressure buildup for toothpaste to reach top of rubber bristles.

This toothpaste travels from the cartridge 5A attached to the rubber bristles or other suitable escape route; this cartridge 5A contains a amount of toothpaste that preferable after a months amount of time is exhausted. This is desirable due to dentist recommendation of purchasing new brush heads after this amount of time. To make this possible for consumers without the expenditure of purchasing new electric toothbrushes every month I have developed a method to switch brush heads and the cartridges interchangeably; easier due in part to the fact that the two are connected. Descriptor 9A shows the approximate location of the separable part of the outer casing of plastic which also contains the cartridge beyond the casings boundaries. The point of separation for the cartridge between the head section and the base of the toothbrush, is at descriptor point 13A where a saw tooth configuration allows the parts to fit into place easily. At 6A it shows that there is a spring panel that when inserted will hit the gradual slope indicated in 7A and after passing the bottom of the said slope 7A will “click” into place by releasing the spring tension. 8A indicates the presence of a button or the like, that will push the spring panel back into place as long as pressure is exerted on the button for the primary purpose of removing the connected cartridge and brush head by sliding it upward from the inner plastic track 10A that holds it back side into place along with keeping in the base with the spring panel 6A.

Toothpaste reaches the rubber bristles, or appropriate release of pressure and product, through a plunger 12A that has a shaft 13A running through it from the final gear disc 21A in gear train 14A. The inner circumference of plunger 12A has a rail track along with the entire shaft from 13A whence it enters the cartridge 5A; so that it may climb the rail track through the rotation of the shaft 13A. When the cartridge and head are separated from the base of the toothbrush the saw tooth configuration 22A from both the drive shaft 1A and rail shaft 13A allows reattachment with new cartridges and brush heads with a considerable amount of ease due in part to the sliding, from the friction of the teeth, into place. The plunger 12A is replaced as it is inside the cartridge and allows it to start from the initial position; as well as both shafts from the point of the saw-toothed configuration 22A are replaced. Both shafts travel the entire distance of the cartridge 5A inside it, this is implied in 11A but not drawn to minimize inspector confusion; the drive shaft is generating in the base from the electric motor 15A, and the rail shaft 13A from the final gear disc 21A in gear train 14A. The drive shaft that travels from the electric motor 15A goes direct into the final gear disc 21A in the gear train 14A. This is possible because the final gear has a hole in the middle of it allowing the passage of the shaft into the rail shaft 13A created on the top face of the final gear 21A. This means that the drive shaft 1A travels the entire distance of the cartridge inside the rail shaft up until descriptor 23A which indicates the end of the rail shaft at the edge of the cartridge; this rail shaft has the option of having its railings on its column end prematurely before the end of the cartridge allowing the plunger 12A to no longer be forced upward on the track at the end of its lifespan. This is done so that users when done with the amount in the cartridge and they still wish to use the toothbrush may do so without destroying the gear train due to backup.

The gear train 14A is a system of gears that reduce the initial RPM generated from the drive shaft gear 24A that is on the drive shaft closely located near the electric motor 15A. This initial drive shaft gear 24A can have about a given RPM of 500 RPM with a given diameter of approx. ¼ inch in contact with the first gear in train that has a ½ inch diameter with a attached gear on its top face in the center of a diameter of ¼ of an inch. These attached gear knobs allow for much greater differential amounts for gear ratios. This is repeated with the next two or any other given amount of gears in the gear train and finally on the final gear disc 21A, with an approx. 1.5 inch diameter; gear 21A has an inverted gear track, in that its teeth are on the inside circumference of a protruding border along the circumference of the disc similar to planetary gear systems. With the given measurements the calculated gear ratio would look like this:

Initial=500 RPM;

Drive shaft gear ¼″ to first gear ½″=250 RPM;

First gear attached knob gear ¼″ to second gear ½″=125 RPM

Second gear attached knob gear ¼″ to third gear ½″=62.5 RPM

Third gear attached knob gear ¼″to final gear disc 1.5″=10.41 RPM

Final Gear Ratio=48.03:1

As you can see this allows for much greater variations between RPM amounts which allow the bristles to move at much faster speeds while the toothpaste is smoothly tapered out.

The power required to drive this machine is provided through an electric motor 15A; all of which is standard to any other electric motor. The electric motor is powered by battery sources 16A which carry electric charges down conducive wires 19A very simple in wiring. This electric loop isn't complete until the user begins ignition of the system preferably through a sort of button. The example drawn here is a piece of conducive metal 17A bent into a V-shape that pops into place. At the bottom end of this metal piece is a spring clasp 20A that allows the spring to only move a certain amount but also allows the user to shut-off the power to the toothbrush by applying pressure on another button 18A that will pop the V-shaped metal piece 19A back into shape when the right amount of pressure is applied; thus ending the electrical current loop.

Figure B. is a sectional zoom view on the gear train for the plunger process. At 1B we see the electric motor that powers the drive shaft 2B, powered by the electric loop entering and exiting from 11B, which in turn spins the drive shaft gear 3B. 4B-6B are the gears for the train that can have any numeric value similar to the examples given for purpose of gear reduction capabilities. The gears preferably would be held by some sort of column configuration; in which there is a column going through the center of each gear allowing free movement and all connecting in a base like figure held in place by the plastic base shell; which is not important to the invention itself but is represented by 15B nonetheless. They all have an attached gear knob smaller in circumference that way they have the same RPM but less distance traveled and thus less turning power; so it increases differential amount in gear ratio. This process all leads to turning the final gear on which the drive shaft runs through 8B and the rail shaft is started on its top face 16B; 9B shows that its meant to continue as shown on Fig. A as does 10B. The gear track is along the inner circumference of the border along the circumference of the disc of the final gear; this is not completely illustrated to avoid viewer confusion but is indicated by 12B. 14B indicates the possibility for twisting the gears around in a step pattern if necessary; which would be poorly illustrated in an attempt to do so; similar to, 13B directs attention to the knob gears atop the upper faces of the gears. These gear measurements are interchangeable as seen fit to further manipulate gear ratios as needed.

While a preferred embodiment embodiment of the Electric Toothpaste Dispensing Toothbrush Mechanism has been described in detail, it should become apparent that modifications and variations are possible, all of which would fall into the true scope of the invention. With respect to the above definitions and terms and given dimensions; all relationships that fall into the true scope of the invention for dimensions, size, variations, materials, shape, form, function, and manner of operation, assembly, and use, are deemed readily apparent and obvious to one skilled in the art, and all equivalent relationships to those illustrated in the drawing and described in the specifications are intended to be included and encompassed in the present invention. Such as the extension of dimension of the cartridge or use of a similar materials to ones provided; would all be generally included as per the intention; of the scope of this invention.

That being so, that herein mentioned is considered only illustrative for the principles of the invention. Furthermore, since numerous changes and modifications readily occur to those skilled in the art, it is not desirable to limit the invention to the exact configuration and operation shown and described, and accordingly, all suitable modifications and equivalents may be resorted to, falling within the scope of the invention.

I claim:

1. A method for automatic distribution of toothpaste in an automated toothbrush comprising a replaceable cartridge and head attachment for replacement, wherein said toothbrush head comprises some sort of exit method for toothpaste with replacement parts common to electric toothbrush heads and said cartridge within contains toothpaste, shafts and a plunger for automation process described.

2. Wherein claim 1 said toothbrush contains gear train for differential amount of RPM generated by motor, for shafts that extend through length of toothbrush through cartridge; for rotation that initiates and continues. plunger advancement for toothpaste release.

3. Wherein claim 1 a toothpaste housing cartridge at which one end leads to an exit at tooth brush head and other has shafts within, ending in a saw tooth configuration which fit into the base shafts continued from the gear train for rotation of the plunger contained therein at the bottom end of the cartridge.

4. Wherein claim I said shafts that run from gear train through cartridge, and shaft that continues to toothbrush head for rotation fits inside shaft meant for plunger advancement attached to part of gear train.

5. The mechanism in claim I wherein the plunger in said cartridge is powered by the rotation of gear train by motor that travels plunger up rail track existing on shaft and inner circumference of plunger; this is to primarily differentiate the speed of the rotation of the shaft meant for toothbrush vibration and the shaft meant for force exerted on the plunger; wherein the speed of the shaft meant for toothbrush bristle vibration is faster and greater than the speed of the shaft meant for plunger advancement.

6. The mechanism in claim I wherein the cartridge contains a spring panel or similar attachment mechanism that allows attachment of said head attachment that clicks into place with latch contained on the inner wall of toothbrush.

7. The mechanism in claim 1 wherein the head attachment may have housing slide rails on cartridge that allow it to slide down guide rails on inner wall of toothbrush plastic cover to anchor head attachment within.

8. The mechanism in claim 1 wherein the housing toothbrush of said mechanism is made to have the upper half containing the brush head, toothpaste cartridge, plunger, shafts beyond saw tooth configuration just after exiting gear train, and housing toothbrush upper encasement removed for replacement.

9. The mechanism in claim 1 wherein initiated process of rotation of shafts from gear train powered by motor begins plunger advancement that delivers toothpaste through toothbrush head opening.

10. A configuration of parts that allow for automated toothpaste distribution in an automated toothbrush or similar device.

11. The configuration in claim 10 wherein initiation of processes begins with the rotation of shafts from gear train powered by a motor causes a plunger, or similar mechanism, to advance pressurizing a housing cavity of toothpaste to the users mouth preferably through a toothbrush head.

12. The configuration in claim 10 where the gear train is the initiator in the process that rotates shafts, one for the bristles and another for plunger advancement on railing, at different rates of RPM thanks to gear reduction ratio created.

13. The configuration in claim 10 wherein the plunger by advancement from shaft travels up a replaceable housing cavity of toothpaste.

14. The configuration in claim 10 wherein a replaceable element exists for the integrated products durability i.e. toothbrush head, as well as the housing cavity for the toothpaste with plunger and other parts contained within.
